(19) United States
(12) Patent Application Publication
(10) Pub. No.: US 2006/0290649 A1
(43) Pub. Date: Dec. 28, 2006

(54) Electrophoretic display and addressing method thereof

(75) Inventors: Mark Thomas Johnson, Eindhoven (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/555,845

(22) PCT Filed: May 4, 2004
(86) PCT No.: PCT/IB04/50573

§ 371 Date: Nov. 3, 2005

(30) Foreign Application Priority Data
May 8, 2003 (EP) 03101274.3

(51) Int. Cl. G09G 3/34

(52) U.S. Cl. 345/107

(57) ABSTRACT

An electrophoretic display comprises a matrix of pixels (18) which comprise electrophoretic material (8, 9) being sandwiched between a top electrode (6) and a bottom electrode (5, 5′). An addressing circuit (16, 10) addresses the pixels (18) during an image update period (IUP) by applying drive voltages (VD) between the top electrode (6) and the second electrodes (5, 5′). The drive voltages (VD) having levels in accordance with an image to be displayed on the electrophoretic display. A controller (15) controls the addressing circuit (16, 10) to supply a series of AC-pulses (ACP) between the bottom electrodes (5, 5′) of neighboring pixels (18) to obtain an electric field (LF) being substantially directed in a plane parallel to the bottom electrodes (5, 5′).

The invention relates to an electrophoretic display, a display apparatus comprising such an electrophoretic display, and a method of addressing the electrophoretic display.

Displays of this type are used in, for example, monitors, laptop computers, personal digital assistants (PDAs), mobile telephones and electronic books, electronic newspapers and electronic magazines.

A display device of the type mentioned in the opening paragraph is known from international patent application WO 99/53373. This patent application discloses an electronic ink display which comprises two substrates, one of which is transparent, the other substrate is provided with electrodes arranged in rows and columns. Display elements or pixels are associated with intersections of the row and column electrodes. Each display element is coupled to the column electrode via a main electrode of a thin-film transistor (further referred to as TFT). A gate of the TFT is coupled to the row electrode. This arrangement of display elements, TFT's and row and column electrodes jointly forms an active matrix display device.

Each pixel comprises a pixel electrode which is the electrode of the pixel which is connected via the TFT to the column electrodes. During an image update or image refresh period, a row driver is controlled to select all the rows of display elements one by one, and the column driver is controlled to supply data signals in parallel to the selected row of display elements via the column electrodes and the TFT's. The data signals correspond to image data to be displayed.

Furthermore, an electronic ink is provided between the pixel electrode and a common electrode provided on the transparent substrate. The electronic ink is thus sandwiched between the common electrode and the pixel electrodes. The electronic ink comprises multiple microcapsules of about 10 to 50 microns. Each microcapsule comprises positively charged white particles and negatively charged black particles suspended in a fluid. When a positive voltage is applied to the pixel electrode, the white particles move to the side of the microcapsule directed to the transparent substrate, and the display element appears white to a viewer. Simultaneously, the black particles move to the pixel electrode at the opposite side of the microcapsule where they are hidden from the viewer. By applying a negative voltage to the pixel electrode, the black particles move to the common electrode at the side of the microcapsule directed to the transparent substrate, and the display element appears dark to a viewer. When the electric field is removed, the display device remains in the acquired state and exhibits a bi-stable character. This electronic ink display with its black and white particles is particularly useful as an electronic book.

Grey scales can be created in the display device by controlling the amount of particles that move to the common electrode at the top of the microcapsules. For example, the energy of the positive or negative electric field, defined as the product of field strength and time of application, controls the amount of particles moving to the top of the microcapsules.

The known display devices show a so-called image retention. After an image change, still remnants of the previous image are visible.

It is an object of the invention to reduce block-edge image retention.

A first aspect of the invention provides an electrophoretic display as claimed in claim 1. A second aspect of the invention provides a display apparatus as claimed in claim 15. A third aspect of the invention provides a method of addressing an electrophoretic display as claimed in claim 16. Advantageous embodiments are defined in the dependent claims.

In recent experiments on active matrix electronic ink displays (further referred to as E-ink displays), a special type of image retention has been observed which is referred to as block-edge image retention. The block-edge image retention is elucidated with respect to the following example wherein the display showed a black block in a white field. After the image is changed to a plain grey or white image, some black/grey stripes appear at the position where the transition from black to white blocks was present. A clear brightness drop is present at or around these lines. This is particularly disturbing, it is more visible than the normal area image retention wherein the total block is somewhat brighter or darker than intended. This block-edge image retention cannot be removed by a general known method proposed for erasing image history or image retention in an E-ink display. In this general proposed method, the entire display is repeatedly reset to black and white using the top (common) and bottom (pixel) electrodes.

It appeared that the block-edge image retention reduces if, in-between successive image update periods, a series of AC-pulses is applied between bottom electrodes of neighboring pixels to generate a field in a plane of the bottom electrodes.

More in general, this approach reduces the block-edge image retention in electrophoretic displays wherein an electrophoretic material is present between two electrodes. The image displayed on the electrophoretic display depends on the voltage applied between these two electrodes which usually are a top and bottom electrodes. The block-edge image retention is reduced by applying AC-pulses between neighboring top electrodes or between neighboring bottom electrodes, such that an electric field occurs which is substantially directed in a plane parallel to either the top or bottom electrodes. This electrical field is also referred to as the lateral electric field.

If the both the top and bottom electrodes are segmented, it is also possible to supply the AC-pulses to both the top and bottom electrodes.

It is thought that the block-edge image retention occurs if two neighboring pixels are switched in an opposite way. For example, one bottom electrode receives a positive potential to obtain a white pixel while the neighboring bottom electrode of the neighboring pixel receives a negative potential to obtain a black pixel. A large lateral electrical field will occur between the neighboring bottom electrodes and thus between the two pixel volumes associated with these bottom electrodes. Due to this lateral electrical field, some particles may move in the lateral direction. As the spacing between these adjacent bottom electrodes is substantially smaller than the distance between the top and bottom electrodes, the lateral fields are considerably higher than the intended driving fields between the top and bottom electrodes. As a result, some particles will stick to the side surface of the pixel volume. These particles cannot be removed from the side surface during the next image update because the voltage pulses applied between the top and bottom electrodes can only move the particles in the vertical direction. These sticking particles result in the block-edge image retention.

These particles appeared to move away from their trapped position by applying an AC lateral field between adjacent pixels.

In an embodiment in accordance with the invention as defined in claim 2, the duration of each one of the pulses of the series of AC-pulses is substantially shorter than a time period required to change an optical state from one limit state (for example, black or white if black and white particles are used) to the other limit state. The particle movement will occur only locally and will not be visible. The amplitude of the pulses should be as large as possible to obtain a higher speed and/or higher efficiency.

In an embodiment in accordance with the invention as defined in claim 3, the series of AC-pulses is supplied between every pair of successive image update periods. In this manner, the reduction of the block-edge image retention is optimal. However, the block-edge image retention will also be reduced if the series of AC-pulses are applied less frequently, as claimed in claims 4 and 5. This will save power and speed up the image refresh time for those image updates where the lateral voltage pulses are not supplied. It would even be possible to detect in an image sequence to be displayed whether the image is susceptible to block-edge image retention and to apply the series of AC-pulses only if required.

In an embodiment in accordance with the invention as defined in claim 6, the series of AC-pulses have a constant amplitude. The constant amplitude is easy to generate with existing drivers.

In an embodiment in accordance with the invention as defined in claim 7, the amplitude of the pulses in the series of AC-pulses decreases in time, the amplitude of the leading pulses of a series is larger than the amplitude of the trailing pulses. It has been experimentally observed that the particles reaction is slower in the initial stage of the pulse sequence. It is thus desired to have higher energy pulses initially followed by lower energy pulses to keep the visibility of the application of the AC-pulses low. Alternatively, or in combination, the pulse width of the pulses in the series of AC-pulses may be varied.

In an embodiment in accordance with the invention as defined in claim 8, a DC-offset is applied to the series of AC-pulses. The (relatively small) DC-offset compensates for built in DC-levels in the driving of the pixels.

In an embodiment in accordance with the invention as defined in claims 9, 10, or 11, the series of AC-pulses are supplied to neighboring pixels sequentially to all columns to reduce the block-edge image retention artifact for vertical lines, or to all rows to reduce the block-edge image retention for horizontal lines, or to both to reduce the block-edge image retention in both directions, respectively.

Combinations of the features of the claims are possible.

These and other aspects of the invention are apparent from and will be elucidated with reference to the embodiments described hereinafter.

In the drawings:

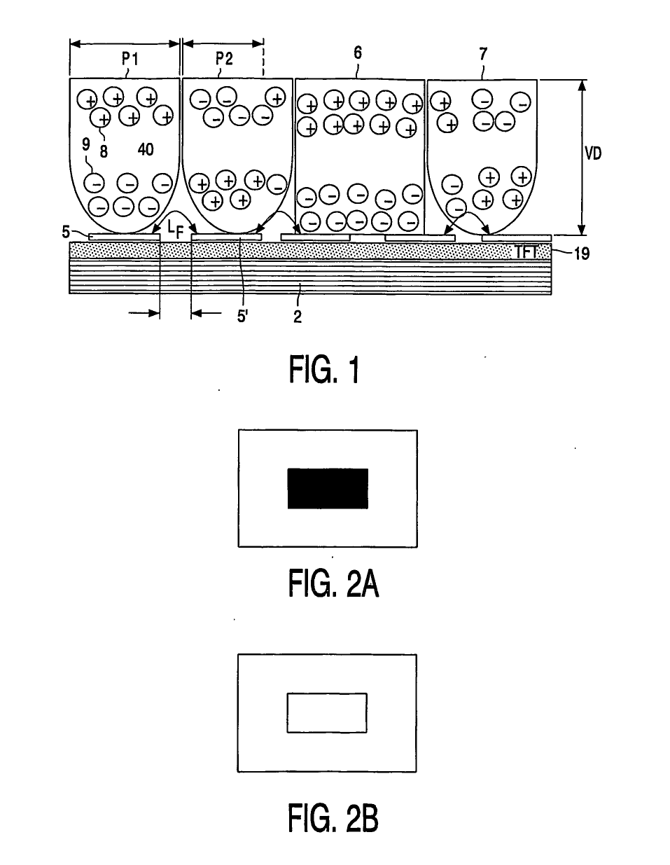

FIG. 1 shows diagrammatically a cross-section of a portion of an electrophoretic display,

FIG. 2 elucidates the block-edge image retention artifact,

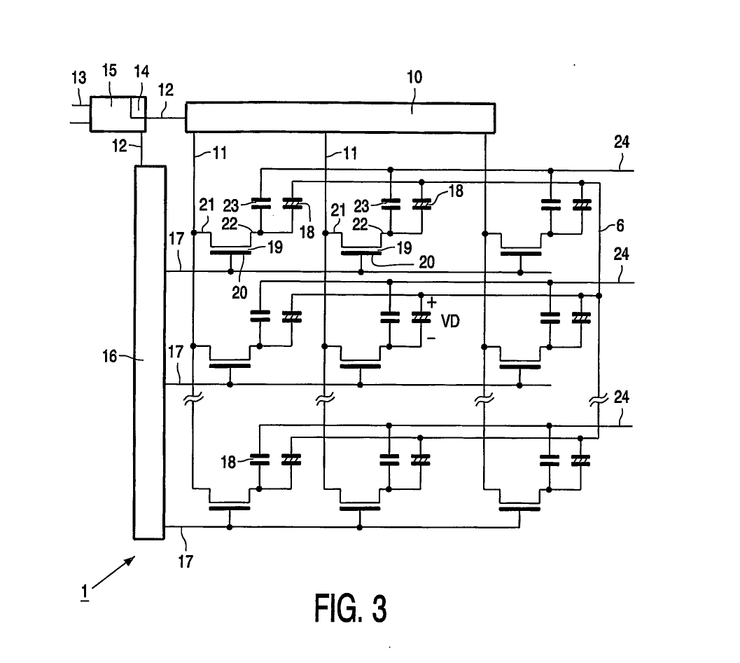

FIG. 3 shows diagrammatically a picture display apparatus with an equivalent circuit diagram of a portion of the electrophoretic display,

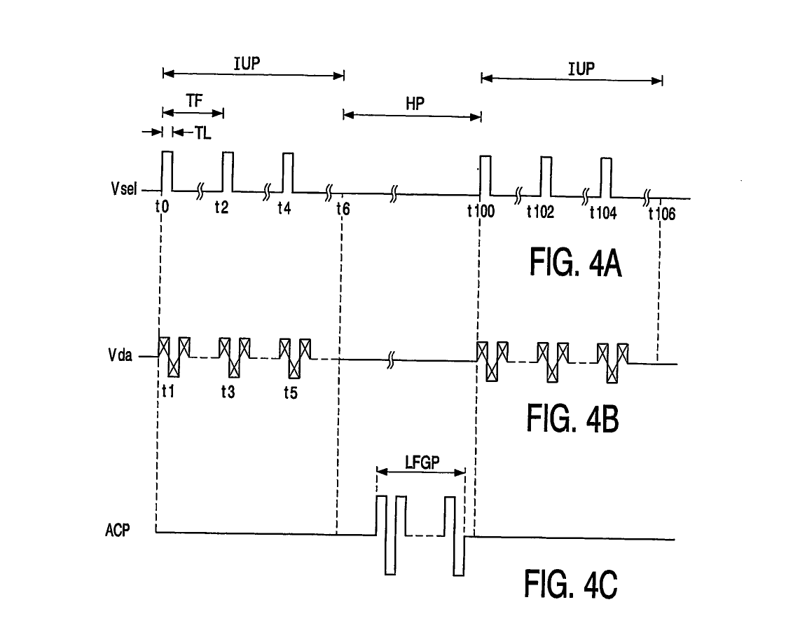

FIG. 4 shows drive signals of an electrophoretic display in accordance with an embodiment of the invention,

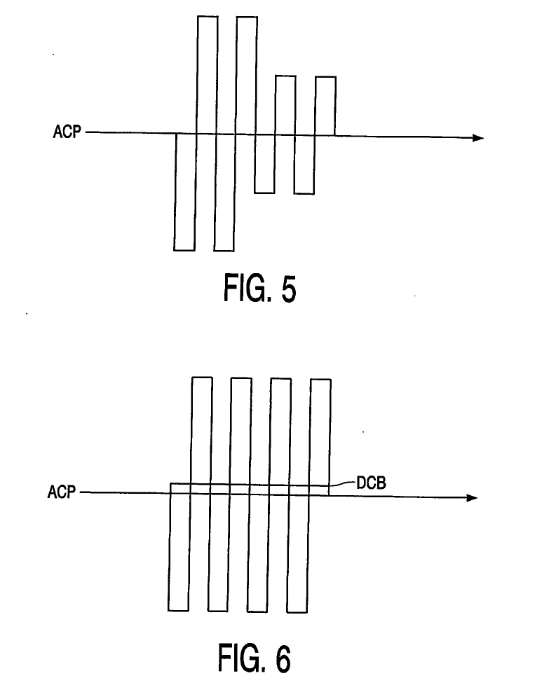

FIG. 5 shows a series of AC-pulses in accordance with an embodiment of the invention, and

FIG. 6 shows a series of AC-pulses in accordance with an embodiment of the invention.

FIG. 1 shows diagrammatically a cross-section of a portion of an electrophoretic display, for example of the size of a few display elements, which comprises a base substrate 2, an electrophoretic film with an electronic ink which is present between transparent pixel electrodes 5, 5′ and a transparent counter electrode 6. The electronic ink comprises multiple microcapsules 7 of about 10 to 50 microns. Each microcapsule 7 comprises positively charged white particles 8 and negatively charged black particles 9 suspended in a fluid 40. When a positive pixel voltage VD is applied to the pixel electrodes 5, 5′ with respect to the counter electrode 6, an electric field is generated which moves the white particles 8 to the side of the microcapsule 7 directed to the counter electrode 6 and the display element will appear white to a viewer. Simultaneously, the black particles 9 move to the opposite side of the microcapsule 7 where they are hidden from the viewer. By applying a negative pixel voltage VD between the pixel electrodes 5, 5′ and the counter electrode 6, the black particles 9 move to the side of the microcapsule 7 directed to the counter electrode 6, and the display element will appear dark to a viewer (not shown). When the electric field is removed, the particles 7 remain in the acquired state and the display exhibits a bi-stable character and consumes substantially no power. Active switching elements 19 (usually TFT's) are provided on the base substrate 2.

In the display shown in FIG. 1, the ideal particle distribution is shown. The position of the particles is determined by the field between the pixel electrodes 5, 5′ and the counter electrode 6. The pixel dimensions are determined by the pixel electrodes 5, 5′ and need not be aligned with the microcapsules 7. The left most pixel P1 associated with the volume of the microcapsule 7 substantially above the corresponding pixel electrode 5 should be white and the adjacent pixel P2 associated with the adjacent pixel electrode 5′ should be black, thus the voltage on the pixel electrode 5 should be positive and the voltage on the pixel electrode 5′ should be negative. The voltage difference between the pixel electrodes 5 and 5′ will cause a large electrical field LF between these pixel electrodes 5, 5′. This electrical field LF will be directed substantially lateral (in the plane of the pixel electrodes 5, 5′) or at least will have a substantial component in the lateral direction. This lateral electrical field LF may cause a few of the negatively charged black particles 9 of the pixel P2 to be attracted to a positive pixel electrode 5 of a neighbouring pixel P1 (not shown). And, in the same manner, the lateral electrical field LF may cause a few of the positively charged white particles 8 of the pixel P1 to be attracted to the negative pixel electrode 5′ of a neighbouring pixel P2.

FIG. 2 elucidates the block-edge image retention artifact. FIG. 2A shows an image which comprises a white area surrounding a black block. FIG. 2B shows the resultant image if immediately after the image shown in FIG. 2A a completely white image is displayed. The resultant picture shows grey lines at the edges of the black block of the previous image. These grey lines are an example of the block edge image retention.

FIG. 3 shows diagrammatically a picture display apparatus with an equivalent circuit diagram of a portion of the electrophoretic display. The picture display device 1 comprises an electrophoretic film laminated on the base substrate 2 provided with active switching elements 19, a row driver 16 and a column driver 10. Preferably, the counter electrode 6 is provided on the film comprising the encapsulated electrophoretic ink. Usually, the active switching elements 19 are thin-film transistors TFT. The display device 1 comprises a matrix of display elements associated with intersections of row or selection electrodes 17 and column or data electrodes 11. The row driver 16 consecutively selects the row electrodes 17, while the column driver 10 provides data signals in parallel to the column electrodes 11 for the selected row electrode 17. Preferably, a processor 15 firstly processes incoming data 13 into the data signals to be supplied by the column electrodes 11.

The drive lines 12 carry signals which control the mutual synchronisation between the column driver 10 and the row driver 16.

The row driver 10 supplies an appropriate select pulse to the gates of the TFT's 19 which are connected to the particular row electrode 17 to obtain a low impedance main current path of the associated TFT's 19. The gates of the TFT's 19 which are connected to the other row electrodes 17 receive a voltage such that their main current paths have a high impedance. The low impedance between the source electrodes 21 and the drain electrodes of the TFT's allows the data voltages present at the column electrodes 11 to be supplied to the drain electrodes which are connected to the pixel electrodes 22 of the pixels 18. In this manner, a data signal present at the column electrode 11 is transferred to the pixel electrode 22 of the pixel or display element 18 coupled to the drain electrode of the TFT if the TFT is selected by an appropriate level on its, gate. In the embodiment shown, the display device of FIG. 1 also comprises an additional capacitor 23 at the location of each display element 18. This additional capacitor 23 is connected between the pixel electrode 22 and one or more storage capacitor lines 24. Instead of TFTs, other switching elements can be used, such as diodes, MIMs, etc. Electrophoretic media are known per se from e.g. U.S. Pat. No. 5,961,804, U.S. Pat. No. 6,1120,839 and U.S. Pat. No. 6,130,774 and may be obtained from E-ink Corporation.

FIG. 4 shows drive signals of an electrophoretic display in accordance with an embodiment of the invention. FIG. 4A shows the select voltage Vsel on a particular one of the row electrodes 17. FIG. 4B shows the data signals Vda supplied to the column electrodes 11. FIG. 4C shows the AC-pulses in accordance with an embodiment of the invention.

At the instant to, the image update period IUP starts. Usually, the first row electrode 17 is energized first by means of the positive pulse of the selection signal Vsel, while simultaneously data signals Vda are supplied to all the column electrodes 11. The plurality of data signals Vda are indicated by crosses. Usually, the data signals Vd are supplied in parallel, one to each data electrode 11 during the line select time TL of the row electrode 17. After the line select period TL has elapsed, a next row electrode 17 is selected at the instant t1, and the data signals Vda for this row of pixels 18 are supplied in parallel, etc. After some time, for example, a field period or frame period TF, usually 16.7 milli seconds or 20 msec, all the row electrodes 17 have been selected and, the particular row electrode 17 is energized again at instant t2 by means of a pulse in the selection signal Vsel for this particular row, while simultaneously the data signals Vd are presented to the column electrodes 11. Again, after the line select period TL has elapsed, the next row electrode is selected at the instant t3. The whole process is repeated starting at instant t4, and so on depending on the number of frames the display has to be addressed during an image update period IUP.

Because of the bistable character of the display device, the electrophoretic particles remain in their selected state and the repetition of data signals can be halted after the several frame periods TF of the image update period IUP when the desired grey level is obtained. In the example shown in FIG. 4, the image update period IUP comprises three frame periods TF, thus the first image update period IUP lasts from t0 to t6. Then, the state of the display is preserved during the hold period HP which lasts from instant t6 to t100. A next image update period IUP lasts from instant t100 to t106.

Up till now, a conventional drive of an electrophoretic display has been described. The invention is directed towards adding the AC-pulses ACP during the hold period HP. These AC-pulses are not applied between the top electrode 6 and the bottom electrode 5, 5′ but are applied between neighbouring bottom electrodes 5, 5′ to obtain the substantially lateral electrical field LF. If the top electrode 6 is segmented (not shown), it may be possible to apply the AC-pulses between neighbouring top electrodes 6. However it is easier to apply the AC-pulses between the bottom electrodes 5, 5′ because the already present switches 19 can be used. The AC-pulses are present during the pulse period LFGP.

If the electrophoretic display is driven without a hold period, in-between two image update periods IUP, time is made free to insert the AC-pulses ACP.

FIG. 5 shows a series of AC-pulses in accordance with an embodiment of the invention. In this embodiment, the AC-pulses have variable amplitude. Initially, a higher amplitude is applied. It has been experimentally observed that the particles reaction is slower in the initial stage of the pulse sequence. It is thus desired to have higher energy pulses initially followed by lower energy pulses to minimize the visibility of these pulses. It is also possible to control the duty cycle of the pulses such that the pulses have a higher energy in the initial stage of the pulse sequence.

FIG. 6 shows a series of AC-pulses in accordance with an embodiment of the invention. In this embodiment, AC-pulses with a DC-bias DCB are used as schematically indicated in FIG. 6. The DC-bias DCB may be required to compensate for DC effects during the driving, such as for example, may be introduced if a longer period is used to drive a pixel from black to white than is used to drive a pixel from white to black.

In a practical method of reducing the block-edge image retention, the AC-pulses ACP are sequentially applied to all the pixels in adjacent columns to reduce the vertical block-edge image retention. The horizontal block-edge image retention can be reduced by applying the AC-pulses ACP to all the pixels in adjacent rows. It is possible to combine these two approaches and to first apply the AC-pulses ACP sequentially to all the pixels in adjacent columns and then to all the pixels in adjacent rows, or the other way around. The selection of the pixels to which the AC-pulses ACP have to be supplied can easily be performed by the switches 19 of the active matrix display. In a more extended embodiment, the AC-pulses ACP are applied to pixels of diagonal lines running across the display.

While the AC-pulses ACP which generate the lateral field LF may be applied between the writing of every subsequent image, it is possible to apply the AC-pulses ACP intermittently. For example, after every ten image updates, or every hour, or every time the display is activated. This will save power and also speed up the image refresh time for those image updates where the AC-pulses are not applied. In addition it would even be possible to detect in an image sequence to be displayed whether the image is susceptible to block-edge image retention and to apply the series of AC-pulses only if required, or alternatively, to apply the pulses more frequently only to those pixels in an image which are more susceptible to block-edge image retention. In both situations, the amount of time required to apply the lateral electrical field will be minimized. Such a detector may comprise a memory to allow to compare two consecutive images and to detect transitions which may give rise to the block-edge image retention. As the lateral pulses can be provided between any adjacent pixels 18 by energizing the adjacent pixel electrodes 5, 5′ it is possible to only energize adjacent pixels 18 where the block-edge image retention is expected to occur.

It should be noted that the above-mentioned embodiments illustrate rather than limit the invention, and that those skilled in the art will be able to design many alternative embodiments without departing from the scope of the appended claims. For example, while in the embodiments described, the AC-pulses are situated in between successive ones of the image update periods, it is also possible to embed the AC-pulses within the image update period.

In the claims, any reference signs placed between parenthesis shall not be construed as limiting the claim. The word “comprising” does not exclude the presence of other elements or steps than those listed in a claim. The invention can be implemented by means of hardware comprising several distinct elements, and by means of a suitably programmed computer. In the device claim enumerating several means, several of these means can be embodied by one and the same item of hardware.

1. An electrophoretic display comprising:
pixels (18) comprising electrophoretic material (8, 9) being sandwiched between a first electrode (6) and second electrodes (5, 5′),
an addressing circuit (16, 10) for addressing the at least one pixel (18) during an image update period (IUP) by applying drive voltages (VD) between the first electrode (6) and the second electrodes (5, 5′), the drive voltages (VD) having levels in accordance with an image to be displayed on the electrophoretic display, and
a controller (15) for controlling the addressing circuit (16, 10) to supply, a series of AC-pulses (ACP) between adjacent ones of the second electrodes (5, 5′) of neighboring pixels (18) to obtain an electric field (LF) being substantially directed in a plane parallel to the second electrodes (5, 5′).

2. An electrophoretic display as claimed in claim 1, wherein the controller (15) is arranged for controlling the addressing circuit (16, 10) to supply, the series of AC-pulses (ACP) in-between successive ones of the image update periods (IUP).

3. An electrophoretic display as claimed in claim 1, wherein a duration of each pulse of the series of AC-pulses (ACP) is substantially shorter than a time period required for changing an optical state of the pixels from a limit state to another limit state.

4. An electrophoretic display as claimed in claim 1, wherein the controller (15) is arranged to control the addressing circuit (16, 10) to supply the series of AC-pulses (ACP) between every pair of successive image update periods (IUP).

5. An electrophoretic display as claimed in claim 1, wherein the controller (15) is arranged to control the addressing circuit (16, 10) to supply the series of AC-pulses (ACP) once every predetermined number of image update periods (IUP), the predetermined number being larger than one.

6. An electrophoretic display as claimed in claim 1, wherein the controller (15) is arranged to control the addressing circuit (16, 10) to supply the series of AC-pulses (ACP) once after every predetermined time period, or at start up of the electrophoretic display only.

7. An electrophoretic display as claimed in claim 1, wherein the controller (15) is arranged to control the addressing circuit (16, 10) to supply the series of AC-pulses (ACP) only when an image is susceptible to block edge artifacts.

8. An electrophoretic display as claimed in claim 1, wherein the controller (15) is arranged to control the addressing circuit (16, 10) to supply the series of AC-pulses (ACP) only to those pixels (18) which are susceptible to block edge artifacts.

9. An electrophoretic display as claimed in claim 1, wherein the addressing (16, 10) circuit is arranged to supply the series of AC-pulses (ACP) with a constant amplitude.

10. An electrophoretic display as claimed in claim 1, wherein the addressing circuit (16, 10) is arranged to supply the series of AC-pulses (ACP) with a decreasing amplitude or a decreasing pulse width in time.

11. An electrophoretic display as claimed in claim 1, wherein the addressing circuit (16, 10) is arranged to supply the series of AC-pulses (ACP) with a DC offset.

12. An electrophoretic display as claimed in claim 1, wherein the controller is arranged to control the addressing circuit (16, 10) to supply the series of AC-pulses (ACP) sequentially to all the pixels (18) in adjacent columns (11).

13. An electrophoretic display as claimed in claim 1, wherein the controller (15) is arranged to control the addressing circuit (16, 10) to supply the series of AC-pulses (ACP) sequentially to all the pixels in adjacent rows (17).

14. An electrophoretic display as claimed in claim 12, wherein the controller (15) is arranged to control the addressing circuit (16, 10) to supply the series of AC-pulses (ACP) both sequentially to all the pixels (18) of the adjacent columns (11) and to all the pixels (18) of the adjacent rows (17).

15. A display apparatus comprising an electrophoretic display as claimed in claim 1.

16. A method of addressing an electrophoretic display comprising pixels (18) comprising electrophoretic material (8, 9) being sandwiched between a first electrode (6) and second electrodes (5, 5′), the method comprising:
addressing (16, 10) the pixels (18), during an image update period (IUP), by applying drive voltages (VD) between the first electrode (6) and the second electrodes (5, 5′), the drive voltages (VD) having levels in accordance with an image to be displayed on the electrophoretic display, and
controlling (15) the addressing circuit (16, 10) to supply a series of AC-pulses (ACP) between the second electrodes (5, 5′) of neighboring pixels (18) to obtain an electric field (LF) being substantially directed in a plane parallel to the second electrodes (5, 5′).
